(19) United States
(12) Patent Application Publication
(10) Pub. No.: US 2010/0228476 A1
(43) Pub. Date: Sep. 9, 2010

(54) PATH PROJECTION TO FACILITATE ENGAGEMENT

(75) Inventors: Avi Bar-Zeev, Redmond, WA (US); Blaise H. Aguera y Arcas, Seattle, WA (US); Stephen L. Lawler, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/398,109

(22) Filed: Mar. 4, 2009

(51) Int. Cl. G01C 21/36

(52) U.S. Cl. 701/209; 701/207

(57) ABSTRACT

The claimed subject matter relates to an architecture that can encourage ad hoc or impromptu engagements between entities as well as simplify or facilitate planning engagements between those entities, all potentially based upon projected routes or paths of the entities. In particular, the architecture can receive location information associated with an entity and can further employ the location information for constructing or updating a path tree for the entity, with each branch of the path tree indicative of a possible or likely future path. Additionally, the architecture can compare the path tree for the entity with a path tree for a disparate entity in order to identify a possible or likely intersection. Moreover, the architecture can generate an intersection notification with details relating to the possible or likely intersection, and provide the intersection notification to one or more entities.

### CROSS-REFERENCE TO RELATED APPLICATIONS

This application is related to U.S. patent application Ser. No. (MSFTP2518US) ______, filed on ______, entitled “AUGMENTING A FIELD OF VIEW IN CONNECTION WITH VISION-TRACKING.” This application is also related to U.S. application Ser. No. 11/767,715, filed on Jun. 25, 2007, entitled “INTENSITY-BASED MAPS.” The entireties of these applications are incorporated herein by reference.

### BACKGROUND

Since commercial access was first granted to Global Positioning System (GPS) and other Global Navigation Satellite Systems (GNSS), as well as various other Location-Based Services (LBS), numerous applications have been built around understanding a user's location, and leveraging that location knowledge, often in connection with a stated destination or near-by points of potential interest. For example, GPS navigation systems where first used in connection with 2-D orthographic projection maps to aid users in getting from one point to another. Eventually, however, GPS (or other LBS systems) expanded to aid in discovering and delivering general information about a user's current location, and could potentially include local business listings, advertisements and so forth.

Hence, given a user's location, conventional devices can provide directions to specific locations and, in some cases, allow users to discover services or content relevant to the current location. Such services can even be helpful at a street-level scale. However, current systems and methods for understanding the location of a user such as GPS do not provide the granularity to understand a user's real context in many ways. Most particularly, such systems are not adequately employed in connection with aggregate users simultaneously.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one or more aspects thereof, comprises an architecture that can encourage engagements between various entities based upon future path projection. In accordance therewith and to other related ends, the architecture can receive location information associated with an entity. Based upon the received data, the architecture can construct (or update) a path tree for the entity. The path tree can include a set of branches, with each branch from the set indicative of a possible future path of the entity. In some cases, the architecture can construct or tag branches as more likely than others, potentially based upon profile information associated with the entity. Accordingly, the path tree can include a subset of branches that are indicative of likely future paths.

Regardless of whether the path tree includes all possible future paths or is limited to only likely future paths, the architecture can compare the path tree for the entity to a path tree for a second entity in order to identify a possible or likely intersection between the two entities. Based upon the identified possible or likely intersection(s), the architecture can generate an intersection notification that can be provided to one or more entities. The intersection notification can include a variety of information relating to location information, projected paths, recommended meeting sites or venues, or the like.

Furthermore, the architecture can maintain the profile associated with the entities and update these profiles in real time based upon any received information, such as location information. The architecture can further maintain a social graph for the entity that can be employed in connection with permission checking, path matching, and revealing or obscuring information associated with the entity to other entities.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer-implemented system that can encourage engagement based upon future path projections.

FIG. 2A illustrates various example types of data that can be included in location information 104.

FIG. 2B depicts various example types of data that can be included in profile 112.

FIG. 3 is a block diagram of a system that can utilize point or vector data in connection with a path tree.

FIG. 4 depicts a block diagram of a system that illustrates additional features or aspects of the logistics component and/or the path tree.

FIG. 5 illustrates a block diagram of a system that can facilitate trust- or permissions-based transactions in connection with encouraging engagements.

FIG. 6 is a block diagram of a system that can provide for or aid with various inferences or intelligent determinations.

FIG. 7 depicts an exemplary flow chart of procedures that define a method for facilitating engagements based upon future path projections.

FIG. 8 illustrates an exemplary flow chart of procedures that define a method for providing addition features in connection with facilitating engagements based upon future path projections.

FIG. 9 depicts an exemplary flow chart of procedures defining a method for employing permissions-based aspects in connection with facilitating engagements based on future path projections.

FIG. 10 illustrates a block diagram of a computer operable to execute or implements all or portions of the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” Therefore, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

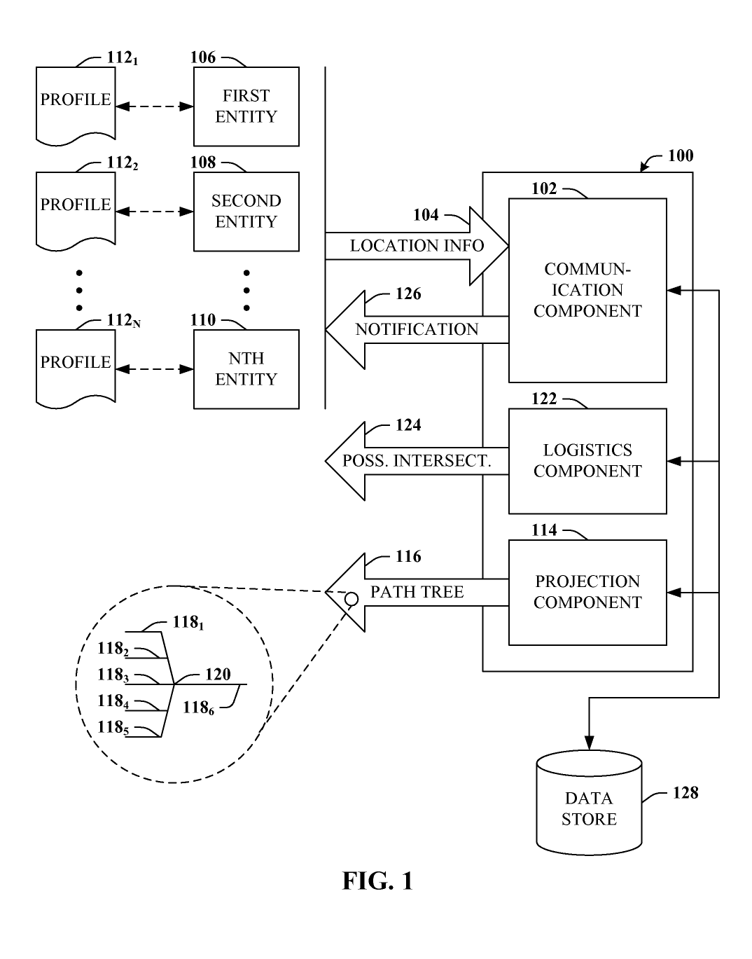

Referring now to the drawings, with reference initially to FIG. 1, computer-implemented system 100 that can encourage engagement based upon future path projections is depicted. Generally, system 100 can include communication component 102 that can receive location information 104, which can be associated with first entity 106. Moreover, location information 104 can likewise be received from all or a portion of a set of N entities, where N is a positive integer. In other words, location information 104 can be received from first entity 106, second entity 108, and so on to the Nth entity 110. Appreciably, location information 104 can differ for each entity 106, 108, or 110 in the type of data presented, the values of the data, or the particular context. Regardless, location information 104 is generally described herein more abstractly or as though relating to a single entity to facilitate ready conceptual understanding of the claimed subject matter.

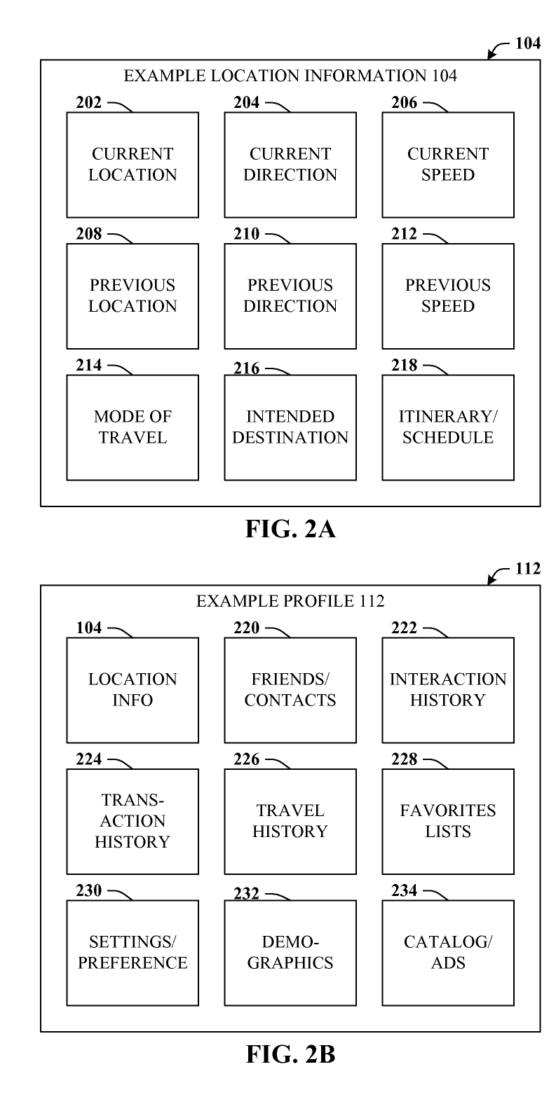

Furthermore, entities (e.g., entities 106-110) described herein can be representative of various individuals, or representative of devices (e.g. a cell phone or mobile device), applications, or agents that serve as proxies for the individuals. However, entities 106-110 can also be representative of corporations, vendors, or other business establishments, organizations, forums, communities, venues and so forth. Regardless of how an entity is characterized, whether an individual or a business, all or a subset of entities 106-110 can be associated with a profile, denoted here as profiles 112₁-112_{N}, and generally referred to hereinafter, either collectively or individually as profile 112, which subscripts generally used only when necessary to call out particular features or avoid confusion. Thus, communication component 102 can also receive all or a portion of profile 112 in addition location information 104, both of which are further detailed in connection with FIGS. 2A and 2B. Moreover, profiles 112 can be maintained in data store 128 that can be immediately accessible to components described herein. Thus, when maintaining profile 112, location information 104 can also be employed to update profile 112 (e.g., updating profile 112 with location information 104).

Accordingly, it should be understood that system 100 can also include or be operatively connected to data store 128. Data store 128 is intended to be a repository of all or portions of data, data sets, or information described herein or otherwise suitable for use with the claimed subject matter. Data store 128 can be centralized, either remotely or locally cached, or distributed, potentially across multiple devices and/or schemas. Furthermore, data store 128 can be embodied as substantially any type of memory, including but not limited to volatile or non-volatile, sequential access, structured access, or random access and so on. It should be understood that all or portions of data store 128 can be included in system 100, or can reside in part or entirely remotely from system 100.

While still referring to FIG. 1, but turning now also to FIGS. 2A and 2B, FIG. 2A illustrates various example types of data that can be included in location information 104. FIG. 2B, similarly depicts various example types of data that can be included in profile 112. Naturally, profiles 112 can differ for different entities 106-110, just as location information can differ (e.g., based upon the type of entity, what is known about the entity, settings or permissions of the entity . . . ). In accordance therewith, example location information 104 can include current location 202. Current location 202 is intended to relate to a physical location of entity 106 (or another entity 108-110), and can be based on a two-dimensional (2D) or a three-dimensional (3D) coordinate system, such as latitude and longitude coordinates (2D) as well as a third axis of height or elevation.

Likewise, example location information 104 can include current direction 204 and current speed 206. Current direction 204 is intended to relate to a direction of travel (if any) for entity 106 or otherwise a direction entity 106 is facing, whereas current speed 206 is intended to relate to how fast entity 106 moves in the direction of travel or that entity 106 is currently stationary. Generally, current location 202, current direction 204, and/or current speed 206 can be obtained by global positioning satellite (GPS) or other location-based services (LBS) or systems, potentially based upon a series of data points.

It should be appreciated that recent or past data for reference numerals 202-206 can be stored to data store 128 or stored elsewhere and transmitted to communication component 102 as previous location 208, previous direction 210, or previous speed 212, respectively, all of which can thus be examples of location information 104. In addition, example location information 104 can include mode of travel 214, for instance, whether first entity 106 is walking, traveling by car or bus, by subway, or the like. Appreciably, mode of travel 214 need not always be received but can be determined or inferred based upon other data included in location information 104. Additionally or alternatively, location information can include intended destination 216 as well as an itinerary or schedule 218. These data can be expressly input by entity 106 or extracted from an associated profile 112 or another application or device. Furthermore, these data can be employed to update or create more accurate future paths since at least one waypoint in path tree 116 can be known in advance.

As noted supra, FIG. 2B relates to various example types of data that can exist in profile 112. Of course, location information 104 can be included in profile 112. In addition, a listing, indication of, or reference to social, business, or other relationships for entity 106 can be included as well as friend/contact list 220. Moreover, various histories can be included in example profile 112 as well such as interaction history 222 (e.g., communications or meetings), transaction history 224 (e.g., purchases, reviews, ratings), or travel history 226 (e.g., past or common destinations or sites).

Furthermore, example profile 112 can include one or more favorites lists 228 which can relate to physical destinations, web or network destinations, friends or contacts 220, to name but a few. Still further, example profile 112 can include numerous settings or preferences 230 as well as demographics 232. Additionally or alternatively, especially when first entity 106 is a business rather than an individual, profile 112 can include various business-based data such as catalog 234, ads, sales, coupons and so on.

Still referring to FIG. 1, system 100 can also include projection component 114 that can construct and thereafter can update path tree 116. It should be appreciated that a distinct path tree 116 can be constructed for each entity 106-110. Path tree 116 can include a set of branches wherein each branch from the set of branches can be indicative of a possible future path of the associated entity 106-110. An example illustration of path tree 116 is provided in the exploded portion of FIG. 1, which depicts six branches 118₁-118₆, any one of which can be representative of a possible future path taken by first entity 106 based upon a current location (e.g., current location 202) of first entity 106, denoted in path tree 116 as point 120. Thus, a current physical location of first entity 106 can be mapped to point 120 in path tree 116, and substantially any path first entity 106 can take in the physical environment can be represented by branches 118. Of course, any number of branches 118 can be represented and, moreover, path tree 116 need not be represented as a tree structure, but can be in other forms or topologies or can be comprised entirely of values or numeric data. It should be understood that one or more path tree 116 can be stored in data store 128 for ready access or recall, and can be updated in real time based upon location information 104.

In addition, system 100 can further include logistics component 122 that can compare a path tree 116 for first entity 106 to a path tree 116 for second entity 108 in order to identify possible intersection 124 between first entity 106 and second entity 108. Moreover, logistics component 122 can construct or update intersection notification 126 in connection with possible intersection 124. Intersection notification 126 can surface or identify information associated with possible intersection 122. Accordingly, intersection notification 126 can be transmitted or provided to one or both first entity 106 or second entity 108 in order to, e.g. inform one or more entities that a rendezvous is possible, likely, or eminent.

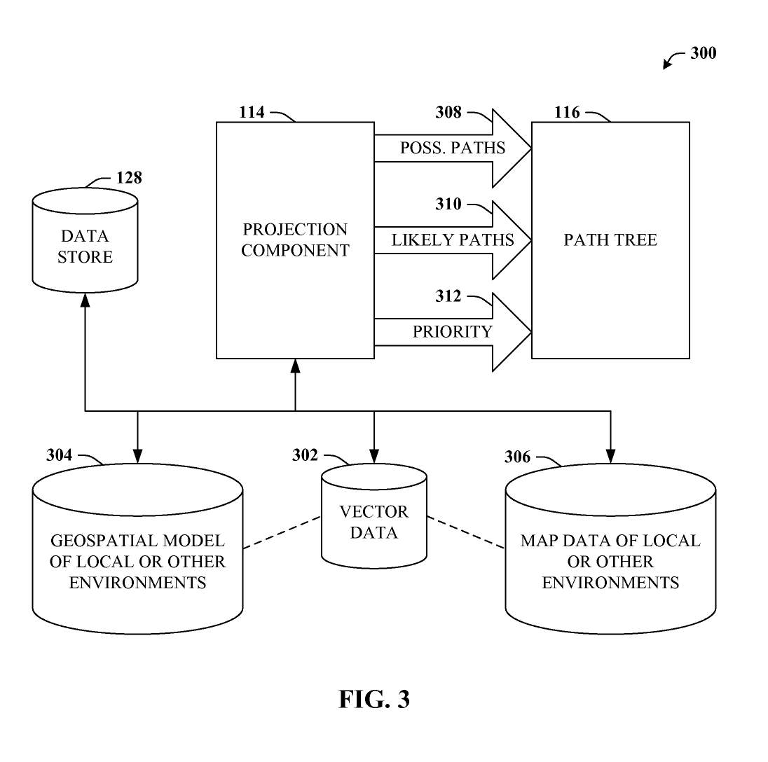

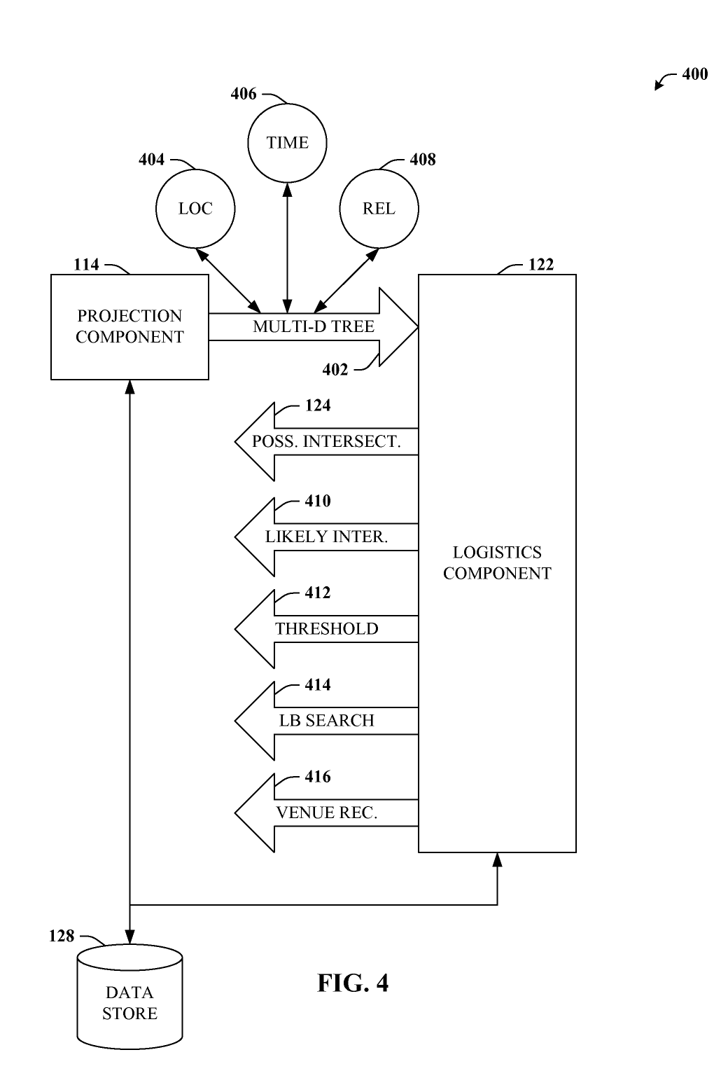

For instance, intersection notification 126 can include a message that states, “If you head over to the museum, it is possible that you will meet Ashley there,” or “It is possible that Ashley is going to the coffee shop that is only 2 minutes away from you now, right down 148^{th} street,” or “Did you know that Ashley is only two blocks away from you? If you remain at this park bench for about 5 minutes, you might see her.” Furthermore, various types of contact information for Ashley can be surfaced automatically. It should be appreciated that intersection notification 126 can be presented or transmitted to an entity 106-110 by way of communication component 102. It should be further appreciated that intersection notification 126 can include a variety of other information, which is discussed in more detail infra. Moreover, additional features, aspects, or further detail in connection with projection component 114 and/or path tree 116 is described with reference to FIGS. 3 and 4; and additional features, details, or other aspects relating to logistics component 122 is further described in connection with FIG. 4.

With reference now to FIG. 3, system 300 that can utilize point or vector data in connection with a path tree is illustrated. In general, system 300 can include projection component 114 that can update or construct path tree 116 based upon location information 104 (or other profile 112 data) as substantially described supra. In addition, projection component 114 can employ vector data 302 in connection with geospatial model 304 of a physical environment and/or in connection with map 306 of the physical environment. Typically, the physical environment will include at least areas, regions, or zones local to one or more of entities 106-110. Accordingly, projection component 114 can leverage existing satellite or street-based mapping systems or services or other LBS components when constructing or updating path tree 11 6.

Vector data 302 can work in connection with substantially any model 304 or map 306 to identify accessibility and/or inaccessibility at a particular location physical location represented by model 304 or map 306. In particular, vector data 302 can identify thoroughfares, stairs, doorways, or the like as well as building or objects, each with associated rules. For instance, vector data 302 can be employed to prevent branches 118 from representing a path through a building or wall. Rather, the associated branch 118 can represent a path to or through a nearby door. Furthermore, the accessibility or the inaccessibility provided by vector data 302 can be a function a particular mode of travel (e.g., mode of travel 214). For example, when traveling by car, parks, sidewalks or the like might be inaccessible, yet accessible if on foot. Likewise, major highways or motorways might be deemed inaccessible when on a bicycle. As another example, when traveling by train, bus, or subway, defined routes or terminus locations can be utilized as well.

As described in connection with FIG. 1, projection component 114 can construct branches 118 that represent various possible paths 308. However, in one or more aspect of the claimed subject matter, projection component 114 can further limit path tree 116 to include only a subset of branches defined by possible paths 308. In particular, each branch 118 in this subset of branches can be limited to include only branches 118 that are indicative of likely future paths 310 rather than the full set of possible future paths 308. Such narrowing of the set of possible future paths 308 to the subset of likely future paths 310 can be accomplished by way of a determination or inference. More particularly, the determination or inference can be based on profile 112 for an associated entity 106-110 or based on a path history of other or similar entities.

For example, if profile 112 is available, then likely paths 310 can be tailored to any suitable specificity. However, if profile 112 is not available, then whatever information that is known about the entity (e.g., data included in location information 104) can be employed, potentially based upon inferences or statistical comparisons with historical data available to the system. Moreover, projection component 114 can also, optionally, assign priority 312 to each likely future path 310 (or possible future path 308), which can also be based upon profile 112, path history of other or similar entities, or any available information.

To provide a concrete example of the above, consider Ross, who does not like shopping malls, which can be derived from various information included in an associated profile or even expressly input. Thus, while walking downtown, an entrance to a nearby shopping mall might be represented as a possible future path 308, however, this path might not be included as a likely future path 310 for Ross when projection component 114 updates path tree 116. It should further be appreciated that although depicted as distinct elements, all or portions of vector data 302, geospatial model 304, or map 306 can be included in whole or in part in data store 128.

Turning now to FIG. 4, system 400 that illustrates additional features or aspects of the logistics component and/or the path tree is provided. In particular, system 400 can include projection component 114 that can build path tree 116 as substantially detailed above. In one or more aspects of the claimed subject matter, path tree 116 can be multi-dimensional tree 402. As one example, multi-dimensional tree 402 can include location dimension 404, time dimension 406, and relationship dimension 408. Of course, other suitable dimensions or axes other than those listed supra can exist as well. Location dimension 404 can relate to a position or location within model 304 or map 306, which itself is a proxy or representation of an associated entity's physical location projected into the future. Thus, when first entity 106 and second entity 108 are in close proximity, respective branches 118 for their trees 402 can also be close or intersect in terms of location dimension 404.

However, if the future location of first entity 106 overlaps or is the same as that for second entity 108, yet the close proximity occurs at different projected future times, then corresponding branches 118 will not intersect in time dimension 406. Conversely, if such does occur, then multi-dimensional tree 402 can illustrate possible paths 308 in which first entity 106 and second entity 108 are projected to be at about the same location at about the same time. In that case, possible intersection 124 can be identified. Similarly, when analysis can be performed relating to likely paths 310, then likely intersection 410 can be identified.

In addition to location 404 and time 406 axes, multi-dimensional tree 402 can include relationship dimension 408 as well. Relationship dimension 408 can relate to a relationship, an association, or a history of interactions or transactions between first entity 106 and second entity 108. For example, if first entity 106 and second entity 108 are complete strangers, while they might be projected to be at the same place at the same time, respective tree 402 branches can still diverge greatly in terms of relationship dimension 408. On the other hand if first and second entities 106, 108 are friends or colleagues, or have exchanged communications (e.g., phone calls, emails, texts messages . . . ) or transactions (e.g. purchases from a vendor entity), then relationship dimension 408 can also intersect.

It should be appreciated that when one or more entity 106-110 is representative of a vendor, then location dimension 404 need not change, but time dimension 406 can reflect, e.g., store hours, and relationship dimension 408 can reflect other interesting characteristics. For example, suppose Ashley tends to shop at a particular vendor when certain products are on sale, or when she shops at that vendor she tends to purchase certain products more often. In that case, when one of these preferred products goes on sale, relationship dimension 408 can reflect a closer association. Hence, should a possible 124 or likely intersection 410 be identified, the corresponding intersection notification 126 can include information relating to the product on sale, potentially along with a bulletin or coupon.

System 400 can also include logistics component 122 that can compare path trees 116, 402 for multiple entities 106-110 in order to determine possible intersections 124 or likely intersections 410 as substantially described supra. Moreover, as described, a possible 124 or likely intersection 410 can be identified only when corresponding branches 118 intersect in all or a relevant subset of dimensions included in multi-dimensional tree 402. Furthermore, logistics component 122 can identify intersections 124, 410 when respective branches 118 approximately intersect within threshold range 412 for each dimension included in multi-dimensional tree 402.

In one or more aspects of the claimed subject matter, threshold range 412 can be determined independently for each dimension in multi-dimensional tree 402 based upon a variety of factors. As one example, each threshold range 412 can be determined based upon input from an associated entity 106-110. For instance, entity 106 can enter criteria for location, time, relationship, or another parameter based upon a particular activity, mood, or schedule. In addition, threshold range 412 can be automatically determined based upon location information 104 or other data included in profile 112. For example, mode of travel 214 can affect threshold range 412 for all dimensions. Thus, by car, a likely intersection 410 can based upon a larger threshold range 412 in terms of distance, yet without a likelihood of changing the mode of travel, vector data 302 can preclude a likely intersection 410, even when very close in terms of distance and time, say, when second entity 108 is projected to be at a location that is inaccessible by car.

In one or more aspects of the claimed subject matter, logistics component 122 can generate a location-based search query 414 in connection with one of possible future path 308, likely future path 310, possible intersection 124, or likely intersection 410. Communication component 102 can transmit search query 414 to, e.g. a specialized location-based search engine or to substantially any network-accessible search engine or component. Moreover, communication component 102 can transmit all or a relevant portion of results from search query 414 to an associated entity 106-110. Appreciably, logistics component 122 can determine the relevant portions of the results or refine search query 414 based an associated profile 112. Thus, results presented to an entity can be based not only on location, but also tailored to the particular entity.

Additionally, logistics component 122 can provide recommendation 416 for an engagement venue for multiple entities 106-110. Typically, recommendation 416 can be based upon results (e.g., places or sites) obtained from location-based search query 414, wherein the particular location associated with likely intersection 410. Therefore, recommendation 416 can be included in intersection notification 126 along with any other suitable data. Moreover, while likely intersection 410 can provide a suitable location on with to base location-based search 414, the actual venue selection included in recommendation 416 can be further based upon an examination of profiles 112 associated with all or a subset of entities 106-110.

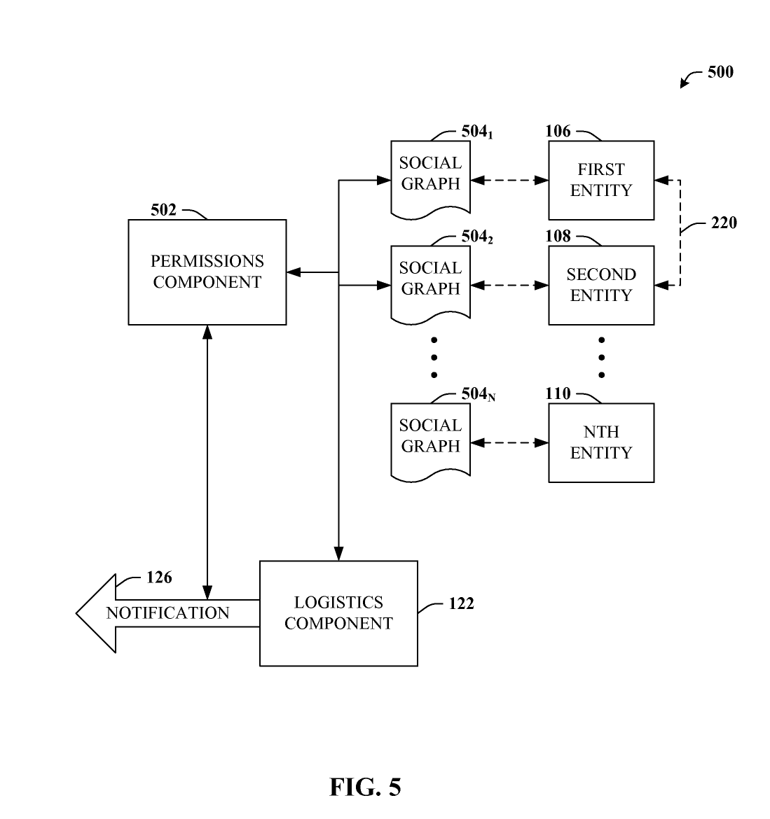

Referring now to FIG. 5, system 500 that can facilitate trust- or permissions-based transactions in connection with encouraging engagements is illustrated. In particular, system 500 can include logistics component 122 that can, inter alia, construct or update intersection notification 126 as substantially described supra. In addition, system 500 can include permissions component 502 that can monitor or manage as well as create one or more social graphs 504₁-504_{N}, hereinafter referred to either collectively or individually as social graph(s) 504. Appreciably, permissions component 502 can be operatively coupled to logistics component 122 as well as to other components described herein. As an example of the above, permissions component 502 can create a social graph 504 for each entity 106-110 that utilizes the claimed subject matter. Social graphs 504 are intended to define or describe relationships, contacts, connections, or networks for the various entities 106-110. Thus, permissions component 502 can leverage information included in profiles 112 or other social networking systems or services in order to maintain social graphs 504.

For example, by examining profiles 112 or other suitable information, permissions component 502 can understand that first entity 106 and second entity 108 are friends, as illustrated by broken line 220, which is intended to indicate a friend or contact 220 discussed in connection with FIG. 2. More particularly, permissions component 502 can select first entity 106 and second entity 108 from among all entities based upon such an association (e.g., that these entities are contacts 220 of one another). Based upon this selection made by permissions component 502, logistics component 122 can compare the respective path trees 116, 402 of these particular entities. In addition, permissions component 502 can make various selections based upon settings, preferences or permissions provided by respective entities 106-110.

For instance, Ashley might only allow her path tree 402 to be compared with close friends, family, or those whom she emails regularly, say at least 3 times per month. Moreover, Ashley might further require any information relating to her be obscured such that others cannot view where she is now but where she was 15 minutes ago, or where she is within a larger area rather than a precise location, or instead of indicating where she was at an exact moment in time, obscure this somewhat to indicate locations she tends to prefer in general. On the other hand, Ross might give permission to compare his path tree 402 to a broader range of third parties, such as all friends as well as friends-of-friends (determined based upon social graph 504). However, in the case in which entity 106 is representative of a business establishment, then that entity might choose to grant unlimited permissions.

Thus, it can be readily appreciated that permissions component 502 can manage or restrict information included in intersection notification 126 based upon settings or permissions of respective entities. Moreover, it can be further appreciated that permissions component 502 can similarly obscure information included in intersection notification 126, wherein the information is obscured by at least one of modification of a current location to a past or recent location or approximation of a current location or a path tree in terms of distance or time. Hence, if permission is granted, and in accordance with the above, a path tree associated with a disparate entity can be included in intersection notification 126 or otherwise delivered to first entity 106. Accordingly, first entity 106 can view projected paths, potentially overlaid over a map, of many of his friends or other entities willing to share this data simultaneously. First entity 106 can also adjust, e.g. a time slider to see the projected paths, either possible or likely, of these entities as well as recommended venues for an engagement. In addition, because information can be obscured, first entity 106 can be more likely to share his or her own data with others.

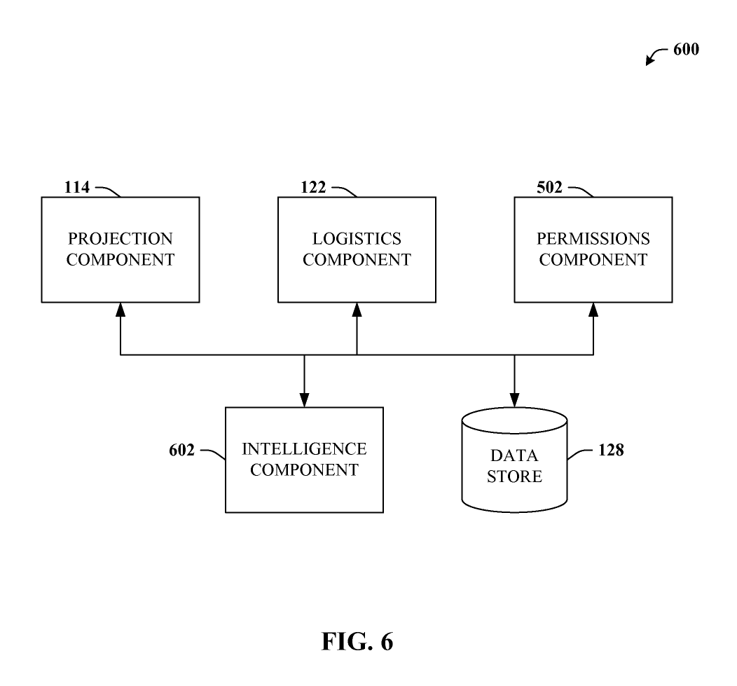

Turning now to FIG. 6, system 600 that can provide for or aid with various inferences or intelligent determinations is depicted. Generally, system 600 can include projection component 114, logistics component 122, or permissions component 502 as substantially described herein. In addition to what has been described, the above-mentioned components can make intelligent determinations or inferences. For example, projection component 114 can intelligently determine or infer or otherwise distinguish likely paths 310 over possible paths 308. Likewise, logistics component 122 can intelligently determine or infer threshold range(s) 412 when comparing path trees of various entities. Logistics component 122 can also intelligently determine or infer recommendation 416, e.g. when suggesting a venue for an engagement between entities. Permissions component 502 can provide for intelligently obscuring information based upon settings or permissions of the entities, for instance. Appreciably, any of the foregoing inferences can potentially be based upon, e.g. Bayesian probabilities or confidence measures or based upon machine learning techniques related to historical analysis, feedback, and/or previous other determinations or inferences.

In addition, system 600 can also include intelligence component 602 that can provide for or aid in various inferences or determinations. In particular, in accordance with or in addition to what has been described supra with respect to intelligent determination or inferences provided by various components described herein. For example, all or portions of projection component 114, logistics component 122, or permissions component 502 (as well as other components described herein) can be operatively coupled to intelligence component 602. Additionally or alternatively, all or portions of intelligence component 602 can be included in one or more components described herein. Moreover, intelligence component 602 will typically have access to all or portions of data sets described herein, such as data store 128, which can encompass or include other data sets such as a profile store, vector data 302, geospatial model 304, map 306, and so forth.

Accordingly, in order to provide for or aid in the numerous inferences described herein, intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

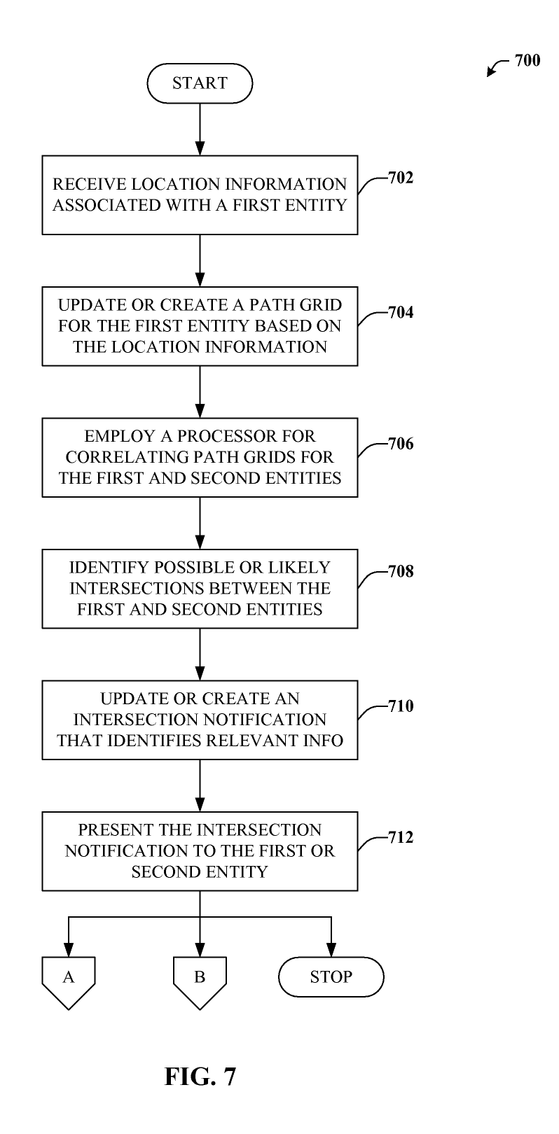

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 7, exemplary computer implemented method 700 for facilitating engagements based upon future path projections is provided. Generally, at reference numeral 702, location information associated with a first entity can be received. The received location information can relate to present or previous locations of the first entity, as well as to speed, direction of travel, mode of travel and so forth. At reference numeral 704, a path grid can be updated or created for the first entity based on the location information. Typically, the path grid can include representations of possible or likely future paths for the first entity. Possible future paths tend to relate to paths that are available for the first entity to traverse, whereas likely future paths are directed more toward paths in which is likely for the first entity to take, potentially based upon what is available to particular locations as well as preferences or behavior associated with the first entity.

Next to be described, at reference numeral 706, a processor can be employed for correlating or comparing the path grid for the first entity to a path grid for a second entity. Based upon the correlation or comparison, at reference numeral 708 possible or likely intersections between the first entity and the second entity can be identified.

When possible or likely intersections between projected paths of the first and second entities are identified, at reference numeral 710, an intersection notification that identifies relevant information in connection with the possible or likely intersection can be updated or created. Appreciably, at reference numeral 712, the intersection notification can be transmitted, provided, or presented to one or both the first entity or the second entity.

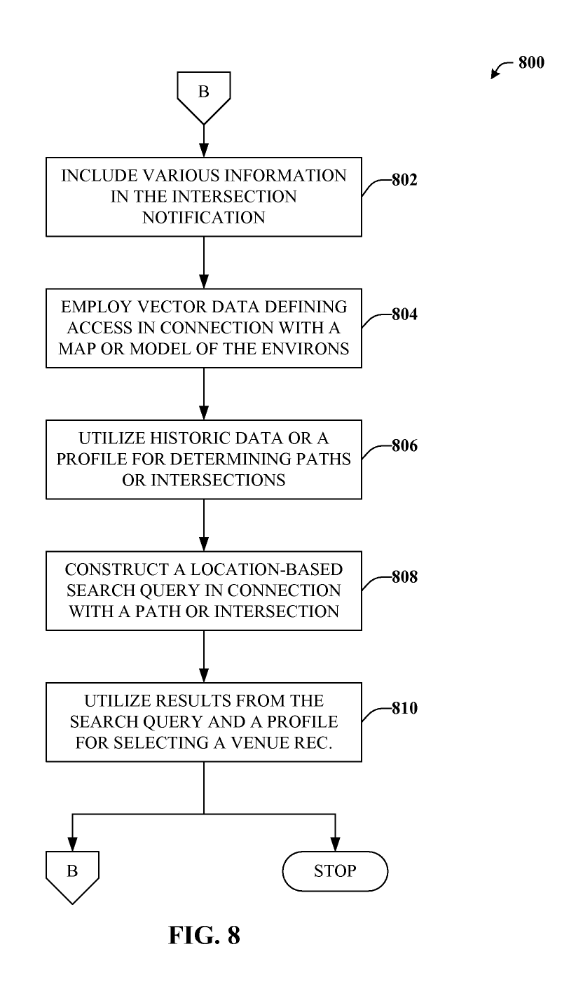

Referring to FIG. 8, exemplary computer implemented method 800 for providing addition features in connection with facilitating engagements based upon future path projections is depicted. At reference numeral 802, at least one of the location information associated with a disparate entity, a path grid associated with a disparate entity, or venue recommendation for an engagement with the disparate entity can be included in the intersection notification presented to the first entity in connection with reference numeral 712 of FIG. 7.

At reference numeral 804, vector data defining accessibility or inaccessibility in connection with a geospatial model of an environment local to the first entity or a map of the environment can be further employed for updating or creating the path grid for the first entity as discussed at reference numeral 704. In addition, at reference numeral 806, historic data or a profile for the first entity can be utilized for determining the likely future paths versus possible future paths. In other words, based upon the profile, many of the possible future paths can be ruled out leaving only a subset of possible future paths that are likely to be traversed by the first entity.

Furthermore, at reference numeral 808, a location-based search query can be constructed in connection with a location associated with a possible future path, a likely future path, a possible intersection between the first entity and the disparate entity, or a likely intersection between the two. Accordingly, at reference numeral 810, results returned from the search query can be utilized for selecting the engagement venue recommendation detailed in connection with reference numeral 802. Appreciably, the engagement venue recommendation can be based upon a profile of the first entity as well as profiles for other entities such as those privy to the intersection notification.

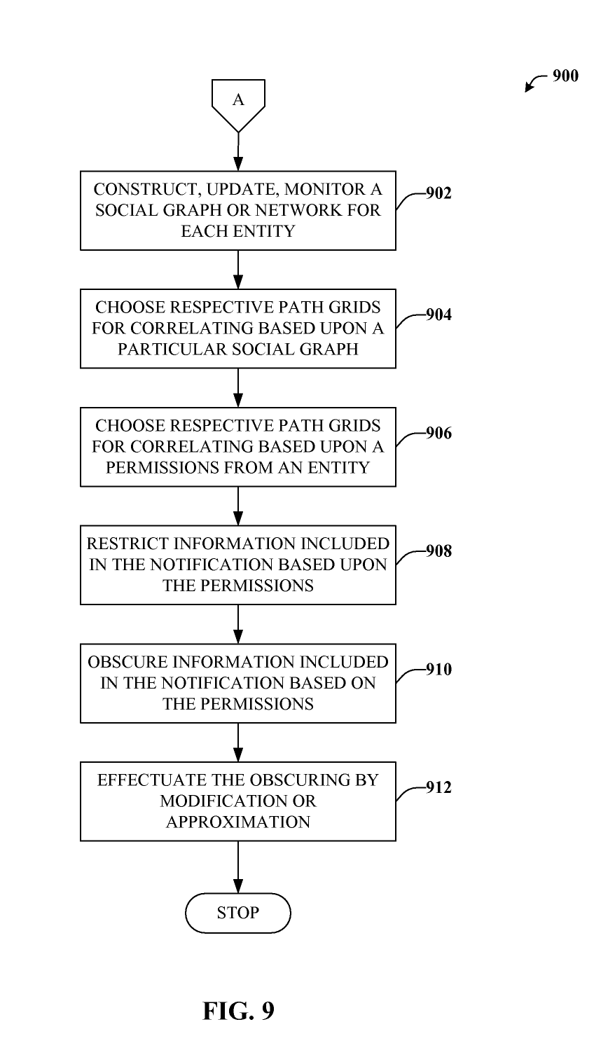

With reference now to FIG. 9, method 900 for employing permissions-based aspects in connection with facilitating engagements based on future path projections is illustrated. At reference numeral 902, a social graph or network for each entity can be constructed, updated, or monitored. Thus, at reference numeral 904, respective path grids can be chosen for correlation or comparison based upon the social graph or graphs of respective entities. Likewise, at reference numeral 906, respective path grids can be chosen for correlation or comparison based upon permissions associated with the respective entities.

Thus, at reference numeral 908, information that is included in the intersection notification discussed in connection with reference numerals 712 and 802 can be based upon the permissions. Moreover, at reference numeral 910, information included in the intersection notification can be obscured based upon the permissions of an entity. In accordance with the above, at reference numeral 912, the obscuring can be effectuated by modifying a current location to a past or recent location, or by approximating a current location or a path grid in terms of time of distance.

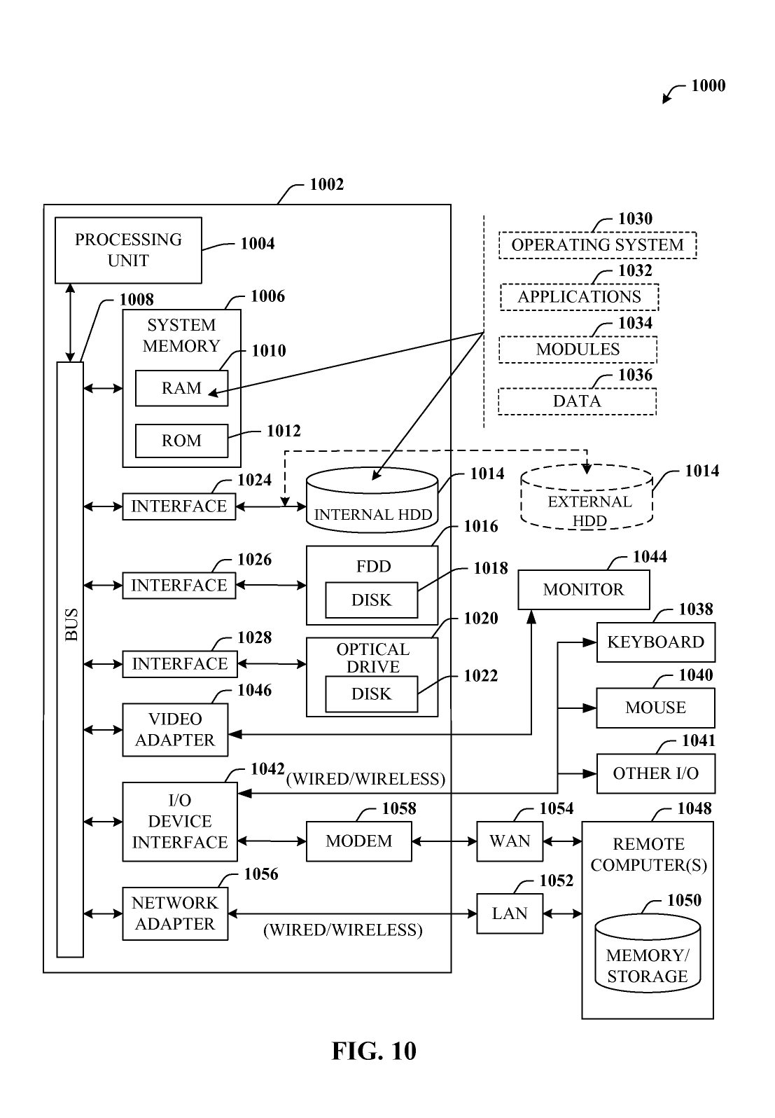

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices 1041 may include a speaker, a microphone, a camera or another imaging device, an IR remote control, a joystick, a game pad, a stylus pen, touch screen, or the like. These and other input devices are often connected to the processing unit 1004 through an input-output device interface 1042 that can be coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, a mobile device, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 10 Mbps (802.11b) or 54 Mbps (802.11a) data rate, for example, or with products that contain both bands (dual band), so the networks can provide real-world performance similar to the basic “10BaseT” wired Ethernet networks used in many offices.

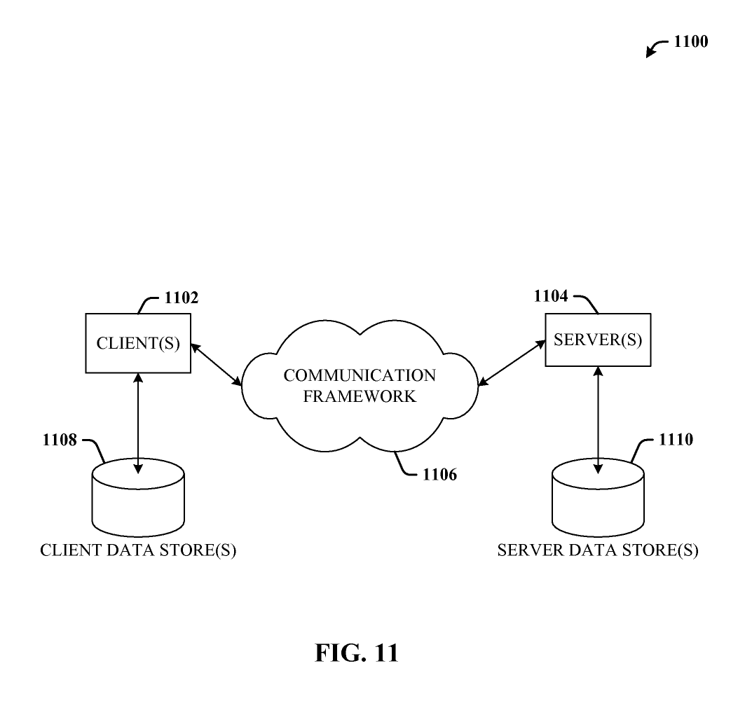

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system that encourages engagement based upon future path projections, comprising:
a communication component that receives location information associated with a first entity;
a projection component that constructs or updates a path tree for the first entity based on associated location information, the path tree includes a set of branches with each branch from the set of branches indicative of a possible future path of the first entity;
a logistics component that compares the path tree for the first entity to a path tree for a second entity in order to identify a possible intersection between the first entity and the second entity, the logistics component constructs or updates an intersection notification that identifies information associated with the possible intersection; and
the communication component transmits the intersection notification to one or both of the first entity or the second entity.

2. The system of claim 1, the location information includes at least one of a current location, a previous location, a current direction of travel, a previous direction of travel, a current speed, a previous speed, a mode of travel, an intended destination, or an itinerary or schedule.

3. The system of claim 1, the projection component employs vector data in connection with a geospatial model of a local environment or a map of the local environment to construct the path tree, the vector data identifies at least one of accessibility or inaccessibility at a particular location of the model or the map.

4. The system of claim 3, the accessibility or the inaccessibility is a function of a particular mode of travel.

5. The system of claim 1, the projection component further limits the path tree to include only a subset of branches, each branch in the subset of branches is indicative of a likely future path that is determined or inferred based upon a profile for an associated entity or based upon a path history of other or similar entities.

6. The system of claim 5, the projection component assigns a priority to each likely future path based upon the profile or based upon the path history of other or similar entities.

7. The system of claim 1, the path tree is a multi-dimensional tree that includes a location dimension, a time dimension, and/or a relationship dimension, the relationship dimension relates to a relationship, an association, or a history of interactions or transactions between the first entity and the second entity.

8. The system of claim 7, the logistics component identifies the possible intersection or a likely intersection when a branch of the path tree for the first entity intersects or approximately intersects within a threshold range in all dimensions included in the multi-dimensional tree.

9. The system of claim 8, the threshold range for each dimension is determined independently based upon at least one of input from an associated entity or based upon the location information or other data included a profile.

10. The system of claim 1, the logistics component generates a location-based search query in connection with at least one of a possible future path, a likely future path, a possible intersection, or a likely intersection; and the communication component transmits all or a relevant portion of results from the search query to an associated entity; the logistics component determines the relevant portion or refines the search query based upon an associated profile.

11. The system of claim 1, the logistics component provides a recommendation for an engagement venue at or near to a likely intersection, and further includes the recommendation in the intersection notification.

12. The system of claim 11, the recommendation is based upon an examination of profiles associated with both the first entity and the second entity.

13. The system of claim 1, further comprising a permissions component that monitors or manages a social graph for each entity.

14. The system of claim 14, the permissions component selects the first and the second entity based on permissions defined by the first entity, the second entity, or combinations thereof, and the logistics component compares associated path trees for selected entities.

15. The system of claim 13, the permissions component manages or restricts information included in the intersection notification based upon the permissions.

16. The system of claim 13, the permissions component obscures information included in the intersection notification based upon the permissions, the information is obscured by at least one of modification of a current location to a past or recent location or approximation of a current location or a path tree in terms of distance or time.

17. A method for facilitating engagements based upon future path projections, comprising:
receiving location information associated with a first entity;
updating or creating a path grid for the first entity based on the location information, the path grid including representations of possible or likely future paths of the first entity;
employing a processor for correlating the path grid for the first entity with a path grid for a second entity;
identifying possible or likely intersections between the first entity and the second entity;
updating or creating an intersection notification that identifies relevant information in connection with the possible or likely intersection; and
presenting the intersection notification to one or both the first entity or the second entity.

18. The method of claim 17, further comprising at least one of the following acts:
including in the intersection notification at least one of location information associated with a disparate entity, a path grid associated with a disparate entity, or an engagement venue recommendation;
employing vector data defining accessibility or inaccessibility in connection with a geospatial model of an environment local to the first entity or a map of the environment for updating or creating the path grid for the first entity;
utilizing historic data or a profile for the first entity for determining likely future paths versus possible future paths;
constructing a location-based search query in connection with a location associated with a possible future path, a likely future path, a possible intersection or a likely intersection; or
utilizing results from the search query for selecting the engagement venue recommendation based upon at least one profile.

19. The method of claim 17, further comprising at least one of the following acts:
constructing, updating, or monitoring a social graph or network for each entity;
choosing respective path grids for correlating based upon a social graph of an entity;
choosing respective path grids for correlating based upon permissions associated with the entity;
restricting information that is included in the intersection notification based upon the permissions;
obscuring information included in the intersection notification based upon the permissions; or
effectuating the obscuring by modifying a current location to a past or recent location or by approximating a current location or a path grid in terms of time or distance.

20. A computer implemented system that encourages engagement based upon future path projections, comprising:
a communication component that receives location information associated with a first entity, and that updates an associated profile with the location information;
a projection component that constructs or updates a path tree for the first entity based on the location information, the path tree includes a set of branches with each branch from the set of branches indicative of a likely future path of the first entity determined based upon information included in the profile;
a permissions component that monitors or manages a social graph for the first entity based upon the profile, and that further selects a second entity based upon the social graph; and
a logistics component that compares the path tree for the first entity to a path tree for the second entity in order to identify a possible intersection between the first entity and the second entity, the logistics component constructs or updates an intersection notification that identifies information associated with the likely intersection.
